(19) United States
(12) Patent Application Publication
(10) Pub. No.: US 2024/0362707 A1
(43) Pub. Date: Oct. 31, 2024

(54) TECHNOLOGIES FOR EFFICIENTLY DETERMINING CREDIT LOSS SENSITIVITY TO MACROECONOMIC IMPACTS

(71) Applicant: The PNC Financial Services Group, Inc., Pittsburgh, PA (US)

(72) Inventor: Abhishek Gupta, Sewickley, PA (US)

(21) Appl. No.: 18/544,521

(22) Filed: Dec. 19, 2023

Related U.S. Application Data
(60) Provisional application No. 63/462,052, filed on Apr. 26, 2023.

(51) Int. Cl. G06Q 40/03

(52) U.S. Cl. CPC G06Q 40/03

(57) ABSTRACT

Technologies for efficiently determining credit loss sensitivity to macroeconomic impacts include a compute device. The compute device includes circuitry configured to determine for each asset category in a set of multiple asset categories, a set of macroeconomic variables that affect a credit loss for the corresponding asset category. The circuitry is further configured to obtain data indicative of a change to be applied to a selected macroeconomic variable of the set of macroeconomic variables. Additionally, the circuitry is configured to calculate, for each asset category determined to be affected by the selected macroeconomic variable, an estimated credit loss resulting from the change in the selected macroeconomic variable while excluding from the calculation one or more asset categories from the set of multiple asset categories that have been determined to not be affected by the selected macroeconomic variable and present, in a user interface, the estimated credit loss.

### CROSS-REFERENCE TO RELATED APPLICATION

This application claims the benefit, under 35 U.S.C. § 119 (e), of U.S. Provisional Patent Application No. 63/462,052, filed Apr. 26, 2023, the entirety of which is hereby expressly incorporated by reference herein.

### BACKGROUND

A bank's income and provisions (i.e., components of the bank's earnings) are a function of credit losses. In turn, credit losses are expected losses from delinquent and bad debt that is likely to default or become unrecoverable. Credit losses are estimated based on an accounting standard known as “Current Expected Credit Loss” (CECL). The estimation of losses under the CECL standard is determined over the life of each credit instrument (e.g., loans, leases, credit cards, etc.) based on underlying risk drivers, transaction attributes, and macroeconomic projections. The risk drivers vary across and within different segments of the same asset categories (e.g., an office segment and a hotel segment of a commercial real estate asset category, a jumbo fixed rate segment and a home equity line of credit segment of a residential mortgages asset category, etc.). For conventional computer systems, performing the calculations across the various asset categories in a portfolio to determine a set of estimated credit losses presents a significant computational load that requires vast amounts of time, energy, and computational resources. As such, immediate redetermination of estimated credit losses under a set of modified risk drivers is not feasible for conventional computer systems. Furthermore, conventional financial computer systems suffer from an inability to succinctly visualize large amounts of information in real time in response to changing input conditions.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for efficiently determining credit loss sensitivity to macroeconomic impacts;

FIG. 2 is a simplified block diagram of at least one embodiment of a compute device of the system of FIG. 1;

FIGS. 3-6 are simplified block diagrams of at least one embodiment of a method for efficiently determining credit loss sensitivity to macroeconomic impacts that may be performed by the system of FIG. 1;

FIG. 7 is a diagram of a structure indicative of macroeconomic variables that have been determined to affect credit losses for each of multiple asset categories that may be produced by the system of FIG. 1;

FIG. 8 is a diagram of a structure indicative of macroeconomic variables that have been determined to affect credit losses for each of multiple asset categories and a set of changes to be applied to the macroeconomic variables that may be produced by the system of FIG. 1;

FIG. 9 is a chart of a shift in a trajectory of a macroeconomic variable after a change has been applied to the macroeconomic variable by the system of FIG. 1;

FIG. 10 is a table of iterations of datasets that may be stored by the system of FIG. 1;

FIG. 11 is a table of loss estimates for each of multiple asset categories that may be produced by the system of FIG. 1;

FIG. 12 is a table that may be produced by the system of FIG. 1, indicating multiple iterations of changes to macroeconomic variables relative to a dataset of asset categories when the macroeconomic variables are unchanged; and

FIG. 13 is a user interface that may be presented by the system of FIG. 1 representing estimated credit losses for asset categories resulting from changes to macroeconomic variables.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

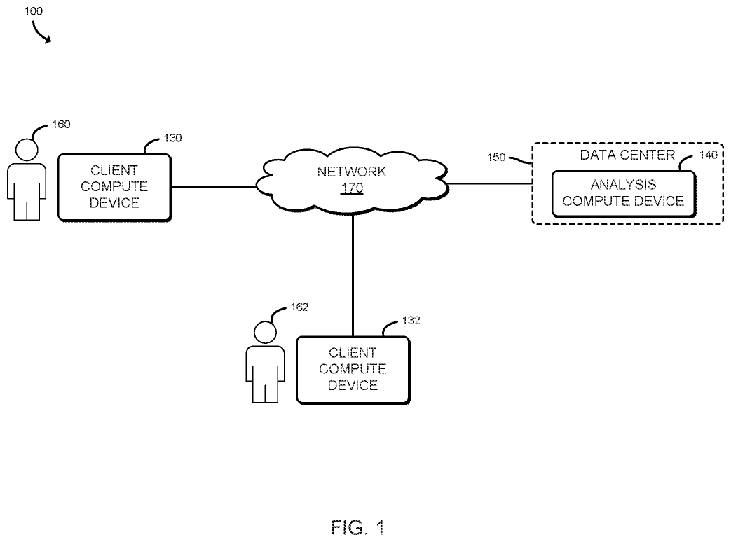

Referring now to FIG. 1, a system 100 for efficiently determining credit loss sensitivity to macroeconomic impacts includes, in the illustrative embodiment, a set of client compute devices 130, 132, each operated by a corresponding user 160, 162, in communication with an analysis compute device 140. While two client compute devices 130, 132 are shown in the system 100, it should be understood that in other embodiments, the number of client compute devices may differ. In the illustrative embodiment, the analysis compute device 140 is housed in a data center 150. While a single analysis compute device 140 and a single data center 150 is shown, it should be understood that the number of analysis compute devices and data centers may differ in other embodiments.

In operation, and as explained in more detail herein, the system 100, and more particularly, the analysis compute device 140, performs a process of efficiently determining the estimated credit loss for asset categories under varying macroeconomic conditions (e.g., macroeconomic variables). As a result of efficiencies in the computational process over conventional systems, the analysis compute device 140 is able to present a user interface that allows a user (e.g., a user 160, 162) of a corresponding client compute device 130, 132 to view a set of results indicative of estimated credit losses and make iterative ad hoc adjustments to the macroeconomic variables to view how estimated credit losses vary with the changes to the macroeconomic variables. That is, the computational efficiencies utilized by the analysis compute device 140 vastly reduce the processing time, energy, and computational resources that would otherwise be consumed to estimate credit losses for a set of asset categories and enable the analysis compute device 140 to dynamically demonstrate the credit loss sensitivity (e.g., an amount by which the estimated credit loss changes) of a portfolio of asset classes under varying macroeconomic conditions (e.g., macroeconomic impacts). In the illustrative embodiment, and as described in more detail herein, the user interface provided by the analysis compute device 140 enables succinct visualization of large amounts of information in real time in response to changing input conditions. In doing so, the system 100 (e.g., the analysis compute device 140) incorporates applied mathematics to provide an improved result over conventional systems in that the system 100 generates and displays reactions to digital input signals (i.e., macroeconomic condition signals) more accurately than in any other financial system.

For purposes of credit loss estimation, each asset category may be divided into segments and a given macroeconomic variable (MEV) may be used differently, through transformations, across different segments of an asset category or across multiple asset categories. The macroeconomic variables may include housing price index, real gross domestic product (GDP), real personal consumption expenditures (PCE), unemployment rate, employment nonfarm, real disposable personal income (DPI), commercial real estate (CRE) price index, new single family home sales, and/or others. Macroeconomic variable data (e.g., data indicative of values of macroeconomic variables) are obtained by the analysis compute device 140 as a time series (e.g., values over time) with historical values and forecasted quarterly or monthly values in reference to spot (i.e., the current time period). A transformation is a functional form of the macroeconomic value used in the credit loss estimation process. Some transformations represent the trajectory of a macroeconomic variable as-is, while others may represent it with a period lag or a moving average of period-over-period variance. Other transformations may be used in other embodiments. As such, even if the same macroeconomic variable is known to be used across different asset categories, the macroeconomic variable may have differing impacts on the credit loss estimations for different asset categories based on the underlying functional form of that macroeconomic variable. In the credit loss estimation process, there may be more than one hundred macroeconomic variables across broad economic indicators, such as labor market participation, inflation, interest rates, and asset prices that are used across different asset categories. To add to the complexity, some macroeconomic indicators are represented by relatable but separate macroeconomic variables. For example, labor market participation may be spread across employment nonfarm, employment farm, and unemployment rates at national and regional levels. These macroeconomic variables may be discretely applied across different asset categories or their underlying segments for the loss estimation process.

In typical systems, an estimate of current expected credit loss is performed every quarter. The estimates may further include qualitative adjustments to estimate provisions, which are disclosed on a bank's income statement, and its companions as allowances for funded and unfunded credit losses on a bank's balance sheet. The quarterly process is based on an analysis of multiple economic scenarios reflecting a range of economic expectations. Unlike typical systems, however, the system 100 (e.g., the analysis compute device 140) executes a highly efficient set of operations to reduce the computational load that would otherwise be required to determine the estimated credit losses across the asset categories as a function of the plurality of macroeconomic variables. In the illustrative embodiment, the system 100 alters only one macroeconomic variable (MEV) at a time, while holding all MEV trajectories unchanged. Further, only the forecasted values (e.g., future values, rather than spot/current value or historical values) of the MEV that is being altered for its impact assessment are changed, in the illustrative embodiment. As a result of these efficiencies, the system 100 may rapidly calculate and present the effects of different values for macroeconomic variables on the estimated credit losses for the asset categories and provide a human user (e.g., a user 160, 162 interacting with the analysis compute device 140 via a corresponding client compute device 130, 132) an intuitive understanding of the interconnected dependencies among the macroeconomic variables. As such, the system 100 may rapidly determine, for a given set of macroeconomic variables, which asset categories of a portfolio (e.g., a bank or other institution's set of asset categories) will be impacted, the relative magnitude of the impact on each of the asset categories, and the aggregate impact on the entire portfolio. In the illustrative embodiment, while the system 100 may present a set of important macroeconomic variables, each outcome illustrated in the user interface represents the impact of just one mapped macroeconomic variable.

As described in more detail herein, the analysis compute device 140 determines (e.g., from a historical analysis) which macroeconomic variables have an oversized effect (e.g., impact) on estimated credit losses for each asset category where they are used (e.g., to determine the importance of each MEV to an impact assessment) and, for a given set of macroeconomic variable(s) that are to be changed (e.g., to determine the resulting effect on credit losses), the analysis compute device 140 calculates the estimated credit loss for only the asset categories that have been determined to be affected by the macroeconomic variable(s) that were changed. As such, the analysis compute device 140 drastically reduces the computational load associated with estimating credit losses by focusing the analysis on only the asset categories that the analysis compute device 140 previously identified as being affected by the macroeconomic variable(s) in question. The analysis compute device 140, in some embodiments, may utilize further streamlined analysis of credit loss estimates, such as interpolation between previously-determined values, as described in more detail herein. These efficiencies enable the system 100 provide a user interface having a level of responsiveness and conciseness in summarizing the effects of changing digital input signals (e.g., indicative of varying macroeconomic conditions) that was previously unattainable by conventional financial computer systems.

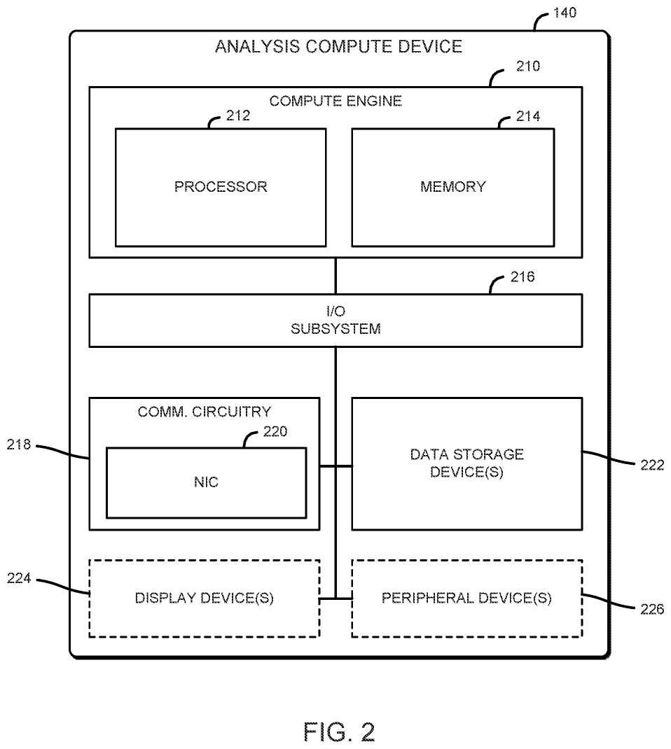

Referring now to FIG. 2, the illustrative analysis compute device 140 includes a compute engine 210, an input/output (I/O) subsystem 216, communication circuitry 218, and one or more data storage devices 222. In some embodiments, the analysis compute device 140 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein. In embodiments, the processor 212 is capable of receiving, e.g., from the memory 214 or via the I/O subsystem 216, a set of instructions which when executed by the processor 212 cause the analysis compute device 140 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as data indicative of asset categories, data indicative of segments within asset categories, macroeconomic variables, credit losses under varying values for macroeconomic variables, machine learning models, applications, libraries, and drivers.

The compute engine 210 is communicatively coupled to other components of the analysis compute device 140 via the I/O subsystem 216, which may be embodied as circuitry and/or components to facilitate input/output operations with the compute engine 210 (e.g., with the processor 212 and the main memory 214) and other components of the analysis compute device 140. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the analysis compute device 140, into the compute engine 210.

The communication circuitry 218 may be embodied as any communication circuit, device, or collection thereof, capable of enabling communications over a network between the analysis compute device 140 and another device (e.g., a client compute device 130, 132, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the analysis compute device 120 to connect with another compute device (e.g., a client compute device 130, 132, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the analysis compute device 140 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the analysis compute device 140 are housed in a single unit. However, in other embodiments, the components may be in separate housings, in separate racks of a data center, and/or spread across multiple data centers or other facilities. The client compute devices 130, 132 may have components similar to those described in FIG. 2 with reference to the analysis compute device 120. The description of those components of the analysis compute device 140 is equally applicable to the description of components of the client compute devices 130, 132. Further, it should be appreciated that any of the devices 130, 132, 140 may include other components, sub-components, and devices commonly found in a computing device, which are not discussed above in reference to the analysis compute device 140 and not discussed herein for clarity of the description.

In the illustrative embodiment, the compute devices 130, 132, 140 are in communication via a network 170, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

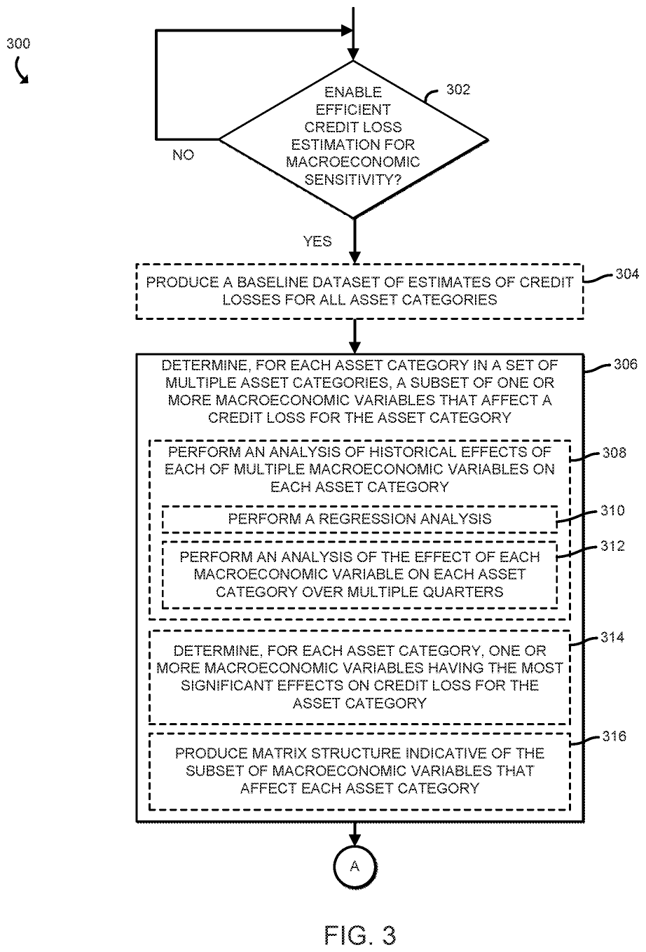

Referring now to FIG. 3, the system 100 (e.g., the analysis compute device 140 in communication with one or more of the client compute devices 130, 132), in the illustrative embodiment, may perform a method 300 for efficiently determining credit loss sensitivity to macroeconomic impacts. The method 300 begins with block 302 in which the analysis compute device 140 determines whether to enable efficient determination of credit loss estimates (i.e., credit loss sensitivity to macroeconomic impacts). In doing so, the analysis compute device 140 may determine to enable efficient determination of credit loss estimates in response to a determination that a configuration setting (e.g., in memory 214 or in storage 222) indicates to enable efficient determination of credit loss estimates, in response to receiving a request (e.g., from a client compute device 130, 132) to enable efficient credit loss estimates, and/or based on other factors. Regardless, in response to a determination to enable efficient determination of credit loss estimates, the method 300 advances to block 304 in which the analysis compute device 140 may produce a baseline dataset representing estimates of credit losses for all asset categories (e.g., all categories of assets in a portfolio of a bank) under a defined set of values (e.g., present values) for underlying risk drivers, including macroeconomic variables. In other embodiments, the dataset indicative of credit losses may have already been produced (e.g., available in the data storage device 222).

Regardless, in continuing the method 300, the analysis compute device 140 in the illustrative embodiment, determines for each asset category in a set of multiple asset categories (e.g., a bank's portfolio), a subset of one or more macroeconomic variables that affect a credit loss (e.g., cause the credit loss to increase or decrease) for the corresponding asset category, as indicated in block 306. In doing so, and as indicated in block 308, the analysis compute device may perform an analysis of historical effects of each of multiple macroeconomic variables on each asset category, as indicated in block 308. For example, the analysis compute device 140 may perform a regression analysis to identify which macroeconomic variables affect credit loss for a corresponding asset category, as indicated in block 310. The analysis compute device 140 may perform an analysis of the effect of each macroeconomic variable on each asset category over multiple (e.g., thirty six or more) quarters, to identify macroeconomic variables that consistently affect credit loss for a given asset category, as indicated in block 312.

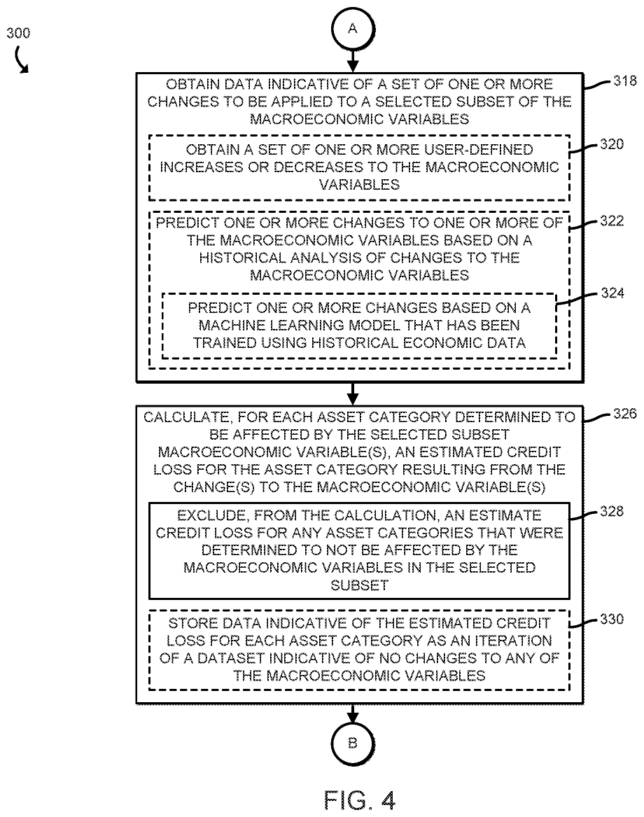

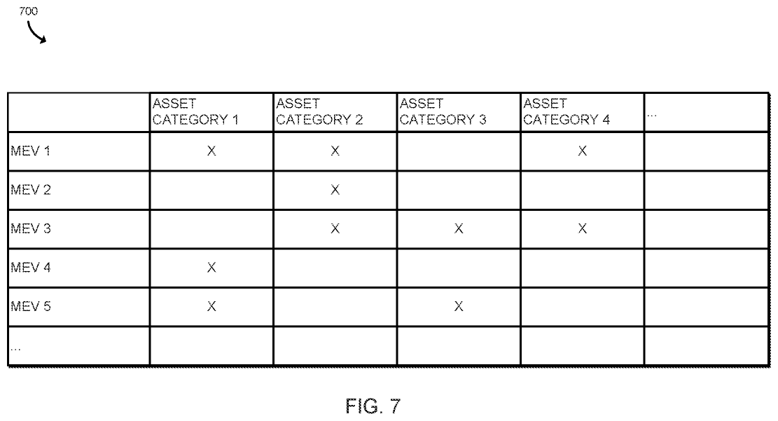

In block 314, the analysis compute device 140 may determine, for each asset category, one or more macroeconomic variable(s) having the most significant effects (e.g., responsible for a threshold amount of variation (e.g., at least 10%)) on credit loss for each asset category. In the illustrative embodiment, the analysis compute device 140 produces (e.g., based on the analysis in block 306) a matrix (e.g., grid, table) structure (e.g., a database table) indicative of the subset of macroeconomic variable(s) that affect each asset category, as indicated in block 316. An illustrative embodiment of the structure 700 is shown in FIG. 7. Afterwards, the method 300 advances to block 318 of FIG. 4, in which the analysis compute device 140 obtains (e.g., from a client compute device 130, 132) data indicative of a set of one or more changes to be applied to a selected subset of the macroeconomic variables.

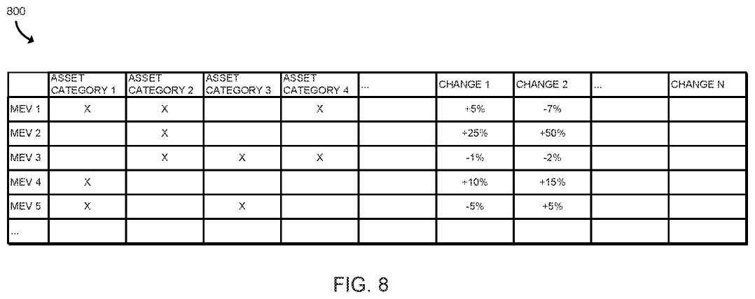

Referring now to FIG. 4, as indicated in block 320, the analysis compute device 140 may obtain a set of one or more user-defined increases or decreases to the macroeconomic variables (e.g., to the selected subset of macroeconomic variables). Additionally or alternatively, the analysis compute device 140 may predict one or more changes to one or more of the macroeconomic variables based on a historical analysis of changes to the macroeconomic variables, as indicated in block 322. In doing so, the analysis compute device 140 may predict one or more changes to the macroeconomic variables based on (e.g., using) a machine learning model (e.g., a neural network, a regression tree model, etc.) that has been trained using historical economic data (e.g., data indicative of changes to macroeconomic variables over time), as indicated in block 324. That is, a machine learning model may be trained based on peak-to-trough and trough-to-peak changes in macroeconomic variables, to predict swings (e.g., direction and magnitude) in the values of the macroeconomic variables, under varying macroeconomic regimes. Referring now to FIG. 8, a representation of a data structure 800 (e.g., presented in a corresponding user interface to a user 160, 162 of a client compute device 130, 132) is shown. The data structure 800 is indicative of the macroeconomic variables that have been determined to influence the credit loss for each asset category and is also indicative of sets of changes (also referred to herein as stresses, impacts, or shocks) to the macroeconomic variables. The changes may be specified by the user 160, 162 or predicted by the analysis compute device 140. In the illustrative embodiment, the changes, each corresponding to a column, are defined as percentage increases or decreases to a corresponding macroeconomic variable (e.g., corresponding to the row). In some embodiments, the changes are defined as nominal value shifts (i.e., change in number of basis points), rather than percentage increases or decreases.

Still referring to FIG. 4, the analysis compute device 140, in block 326, calculates, for each asset category that was determined to be affected by the selected subset of macroeconomic variables, an estimated credit loss for the corresponding asset category. That is, the analysis compute device 140 determines the estimated credit loss resulting from the change(s) to the macroeconomic variable(s) (e.g., the one or more changes obtained in block 318). In doing so, and as indicated in block 328, the analysis compute device 140 excludes, from the calculation, estimated credit losses for any asset categories that have been determined (e.g., from the analysis in block 306 and the resulting data structure) to not be affected by the macroeconomic variables in the selected subset (i.e., the macroeconomic variables being changed). By focusing the calculation on only the asset categories that have been pre-identified as being affected by the macroeconomic variables at issue, the analysis compute device 140 may drastically reduce the amount of time, energy, and computational resources (e.g., processor cycles, memory, etc.) that would otherwise be consumed to recalculate estimated credit losses across all asset categories in a portfolio (e.g., a bank's portfolio).

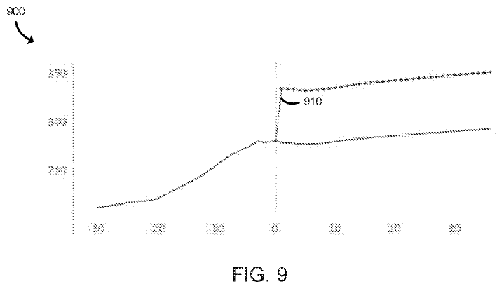

As indicated in block 330, the analysis compute device 140, in the illustrative embodiment, stores data indicative of the estimated credit loss for each asset category (e.g., estimated credit losses resulting from the changes to the macroeconomic variables) as an iteration of a dataset that is indicative of no changes to any of the macroeconomic variables (e.g., as an iteration of the dataset from block 304). For example, an “MEV 1 & Change 1” iteration may represent a dataset of all the macroeconomic variables as unchanged, with only MEV 1 changed by +5%. The process of creating and storing sets (e.g., iterations) of unchanged and changed macroeconomic variables for different combinations of macroeconomic variables provides computational efficiencies by enabling the analysis compute device 140 to quickly reference (e.g., read from the data storage 222) data associated with a change in macroeconomic values, on an as-requested basis, without the need to recalculate any of the data. Referring now to FIG. 9, a chart 900 illustrates a parallel upward shift 910 in the projected trajectory for a changed macroeconomic variable. The change is applied from a projected period onwards, relative to spot (represented as the “0” point on the x-axis), to cause a parallel shift upwards (or downwards) of the entire projected trajectory of that changed macroeconomic variable only.

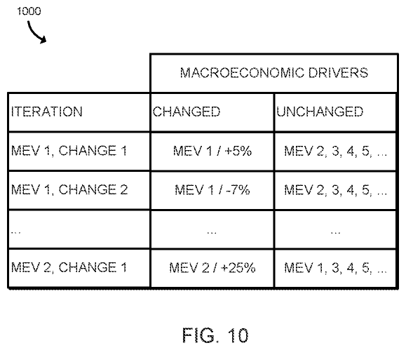

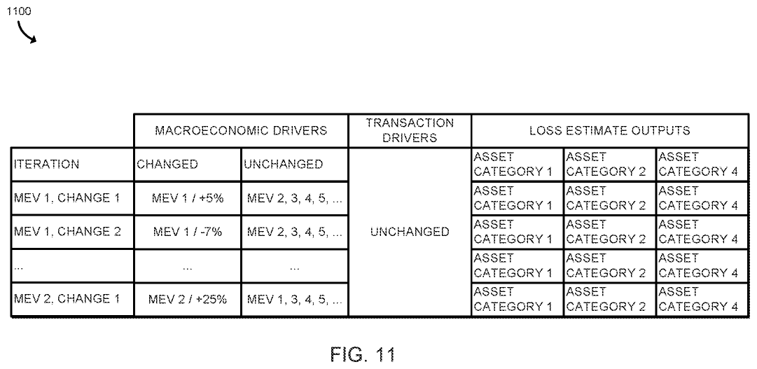

Referring now to FIG. 10, a table 1000 of iterations of datasets that may be stored by the analysis compute device 140, corresponding to changes to macroeconomic variables as described above, is shown. In the illustrative embodiment, for each iteration, the analysis compute device 140 uses the same underlying transaction data (e.g., risk driver not being stressed) and uses the macroeconomic data (e.g., macroeconomic variables) from the iteration where a selective change has been applied only to the macroeconomic variable(s) being stressed. The analysis compute device 140, in the illustrative embodiment, writes the final output of each asset category's loss estimates in the corresponding iteration directory (e.g., dataset corresponding to a particular iteration), as indicated in the table 1100 of FIG. 11.

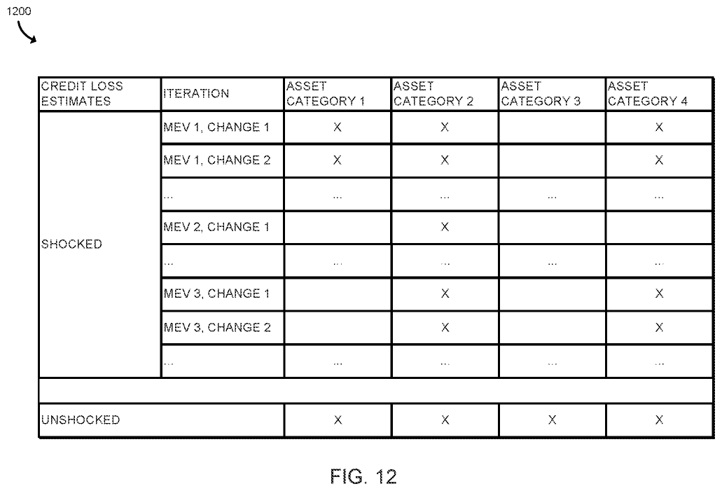

In the illustrative embodiment, the analysis compute device 140 aggregates and summarizes the outputs (e.g., credit loss estimates) of each iteration of changes to the macroeconomic variables. The analysis compute device 140 also reads in (e.g., from data storage 222) an estimate of the estimated credit losses without the changes to the macroeconomic variables (e.g., the dataset from block 304 of FIG. 3), for a relative impact assessment. The table 1200 of FIG. 12 illustrates multiple iterations of shocks (e.g., changes) to macroeconomic variables relative to a dataset of the asset categories (e.g., a bank's portfolio) when the macroeconomic variables are unchanged (e.g., the dataset from block 304).

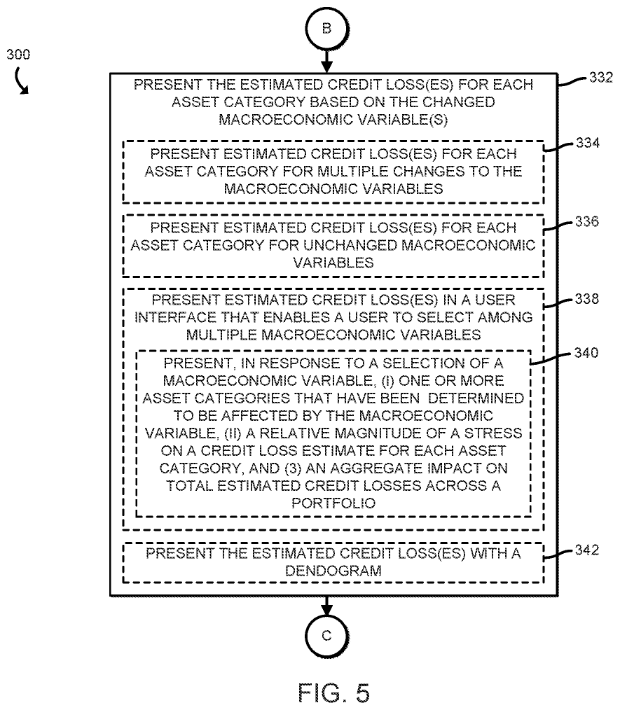

Referring now to FIG. 5, the method 300 advances to block 332 in which the analysis compute device 140 presents (e.g., by transmitting code, such as hypertext markup language (HTML) code and data (e.g., graphics), to a client compute device 130, 132 for rendering in a web browser or other application with a corresponding rendering engine) the estimated credit losses for each asset category based on the changed macroeconomic variables. In doing so, the analysis compute device 140 may present estimated credit losses for each asset category for multiple changes to the macroeconomic variables (e.g., multiple changes to a single macroeconomic variable, changes to multiple macroeconomic variables, etc.), as indicated in block 334. Additionally, in the illustrative embodiment, the analysis compute device 140 presents estimated credit losses for each asset category for unchanged macroeconomic variables (e.g., the baseline dataset from block 304), as indicated in block 336. In the illustrative embodiment, and as indicated in block 338, the analysis compute device 140 presents the estimated credit losses in a user interface that enables a user (e.g., a user 160, 162) to select among multiple macroeconomic variables. The analysis compute device 140, in the illustrative embodiment, provides a user interface that presents, in response to a selection of a macroeconomic variable, one or more asset categories that have been determined to be affected by the selected macroeconomic variable, a relative magnitude of a stress on a credit loss estimated for each asset category, and an aggregate impact on total estimated credit losses across a portfolio (e.g., of a bank), as indicated in block 340. The analysis compute device 140, in the illustrative embodiment, presents the estimated credit losses in a user interface that includes a dendogram (i.e., a diagram that shows the hierarchical relationship between objects), as indicated in block 342. As such, unlike conventional financial computer systems in which the relationships between input conditions and effects of those input conditions on credit losses is not made apparent to the user (e.g., because the computer system is unable to identify the relationships in a timely manner and/or is unable to convert it to a visual format), the system 100 provides succinct visualization of large amounts of information in real time in response to changing input conditions (e.g., digital input signals indicative of macroeconomic condition signals).

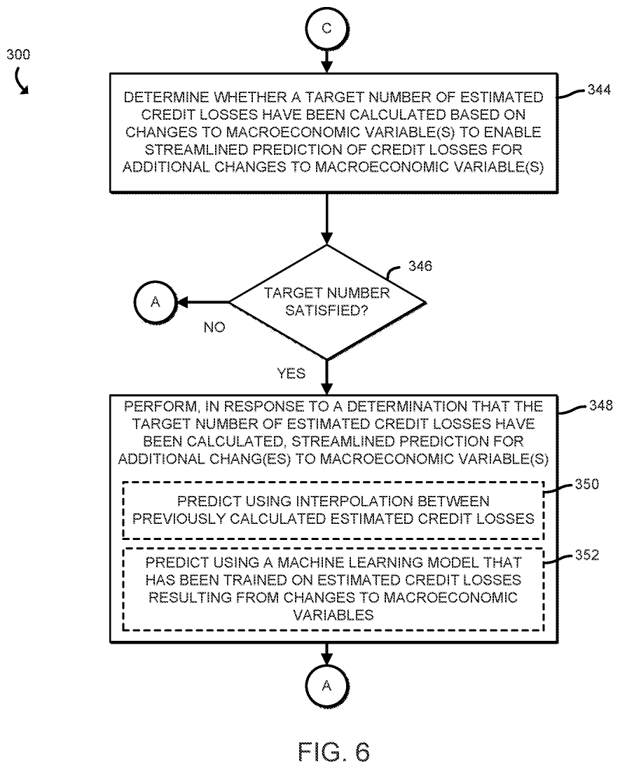

Referring now to FIG. 6, the analysis compute device 140 may perform more efficient calculations of credit loss estimates after a target number of estimated credit losses have been performed (i.e., further increasing the responsiveness of the user interface to changing input conditions), as described herein. In block 344, the analysis compute device 140 determines whether a target number (e.g., a predefined number) of estimated credit losses have been calculated based on changes to macroeconomic variables to enable streamlined prediction of credit losses for additional changes to macroeconomic variables (e.g., additional iterations representing additional changes to values of selected macroeconomic variables). In block 346, the analysis compute device 140 determines the subsequent course of action based on the result of the determination in block 344. If the target number of estimated credit losses has not been calculated, the method 300 loops back to block 318 of FIG. 4, in which the analysis compute device 140 may obtain data indicative of a set of one or more changes to be applied to a selected subset of the macroeconomic variables (e.g., another iteration of changes to macroeconomic variables to be tested). Otherwise, if the target number of estimated credit losses have been calculated, the method 300 advances from block 346 to block 348, in which the analysis compute device 140 performs streamlined prediction for additional changes to macroeconomic variables. In doing so, and as indicated in block 350, the analysis compute device 140 may predict estimated credit losses by interpolating between previously calculated estimated credit losses (e.g., previously calculated credit losses based on values of macroeconomic variables that are greater than and less than a present set of values for the macroeconomic variables). Additionally or alternatively, the analysis compute device 140 may predict estimated credit losses using a machine learning model (e.g., a neural network, a regression tree model, etc.) that has been trained on estimated credit losses resulting from changes to macroeconomic variables, as indicated in block 352. In the illustrative embodiment, the streamlined analysis provides for reduced computational load on the analysis compute device 140 and lower response time in updating the visualization (e.g., visual representation in the user interface) of the effects of changing input conditions (i.e., changed macroeconomic variable(s)).

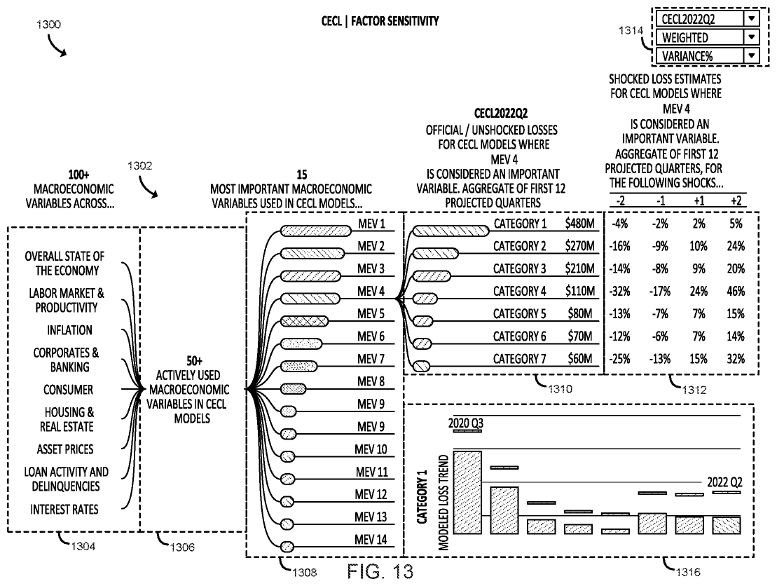

Referring now to FIG. 13, a user interface 1300 presented by the analysis compute device 140 (e.g., by transmitting corresponding code and graphics to a client compute device 130, 132 for rendering thereon) includes a dendogram 1302 representing a first set 1304 of macroeconomic variables, a second set 1306 of macroeconomic variables that is a subset of the first set 1304, and a third set 1308 of macroeconomic variables, which is a subset of the second set 1306. The macroeconomic variables in the third set 1308 have been determined by the analysis compute device 140 to be significant factors in determining credit losses for a corresponding set 1310 of asset categories. In response to selection of a particular macroeconomic variable (MEV 4), the user interface 1300 displays the corresponding set 1310 of asset categories have been determined to be significantly influenced by the selected macroeconomic variable (MEV 4). For each asset category in the set 1310, a corresponding credit loss is displayed based on unchanged values for the selected macroeconomic variable (MEV 4). That is, the credit loss for each asset category in the set 1310 is based on the baseline dataset (e.g., from block 304 of the method 300). A section 1312 of the user interface 1300 displays relative changes to the asset categories in the set 1310 resulting from changes in the value of the selected macroeconomic variable (MEV 4). For example, a change of −2% to the selected macroeconomic variable has been determined, by the analysis compute device 140, to cause a −4% change in the estimated credit loss for a first asset category (CATEGORY 1) in the set 1310. Continuing the example, a change of −1% to MEV 4 has been determined, by the analysis compute device 140, to result in a −2% change in the credit loss for the first asset category. Further, a change of +1% to MEV 4 has been determined to result in a 2% increase in the credit loss for the first asset category and a change of +2% to MEV 4 has been determined to result in a 5% increase in the credit loss for the first asset category. As such, unlike conventional financial computer systems in which a desired output may be difficult to interpret, obscured by extraneous or irrelevant information, or otherwise not readily available (e.g., due to technical limitations), the system 100, through the user interface 1300, enables succinct visualization of large amounts of information in real time in response to changing input conditions.

The user interface 1300 also includes options to customize the output of information, to enhance a user's comprehension of the effects of changing input values (e.g., of macroeconomic variable(s)), as described below. A section 1314 of the user interface 1300 includes a set of user interface elements (e.g., dropdown lists) for selecting a different mode in which to present data. The options include selection of the time period associated with the estimated credit losses, whether the results are weighted or not, and whether to present changes in estimated credit losses as percentage changes relative to the baseline value or as actual values. In response to user selection of an option from section 1314, the user interface 1300 updates the displayed data correspondingly. Additionally, a section 1316 of the user interface 1300 presents historical values of a selected asset category (e.g., CATEGORY 1) to provide the user (e.g., a user 160, 162) with context on how the present estimated credit losses compare to credit losses for the asset category in previous time periods. In the illustrative embodiment, the section 1316 is updated with historical information for another asset category (e.g., CATEGORY 2) in response to detecting a user selection of that asset category (e.g., upon detecting that the user has clicked on or touched CATEGORY 2).

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to determine for each asset category in a set of multiple asset categories, a set of macroeconomic variables that affect a credit loss for the corresponding asset category; obtain data indicative of a change to be applied to a selected macroeconomic variable of the set of macroeconomic variables; calculate, for each asset category determined to be affected by the selected macroeconomic variable, an estimated credit loss resulting from the change in the selected macroeconomic variable while excluding from the calculation one or more asset categories from the set of multiple asset categories that have been determined to not be affected by the selected macroeconomic variable; and present, in a user interface, the estimated credit loss.

Example 2 includes the subject matter of Example 1, and wherein to determine a set of macroeconomic variables that affect a credit loss for the corresponding asset category comprises to perform an analysis of historical effects of each of multiple macroeconomic variables on the corresponding asset category to identify a subset of the macroeconomic variables that affect a credit loss for the corresponding asset category.

Example 3 includes the subject matter of any of Examples 1 and 2, and wherein to determine the set of macroeconomic variables comprises to perform an analysis of historical effects of each macroeconomic variable over multiple quarters.

Example 4 includes the subject matter of any of Examples 1-3, and wherein to determine the set of macroeconomic variables comprises to perform a regression analysis.

Example 5 includes the subject matter of any of Examples 1-4, and wherein to determine a set of macroeconomic variables that affect a credit loss for the corresponding asset category comprises to identify one or more macroeconomic variables from the set having at least a predefined threshold effect on the credit loss for the corresponding asset category.

Example 6 includes the subject matter of any of Examples 1-5, and wherein to determine for each asset category in a set of multiple asset categories, a set of macroeconomic variables that affect a credit loss for the corresponding asset category comprises to produce a matrix structure indicative of macroeconomic variables that affect each asset category.

Example 7 includes the subject matter of any of Examples 1-6, and wherein to obtain data indicative of a change to be applied to a selected macroeconomic variable comprises to obtain a user-defined increase or decrease of the selected macroeconomic variable.

Example 8 includes the subject matter of any of Examples 1-7, and wherein to obtain data indicative of a change to be applied to a selected macroeconomic variable comprises to predict a change to the selected macroeconomic variable based on a historical analysis of changes to the selected macroeconomic variable over time.

Example 9 includes the subject matter of any of Examples 1-8, and wherein to predict the change to the selected macroeconomic variable comprises to predict the change with a machine learning model that has been trained to predict changes to macroeconomic variables based on historical economic data.

Example 10 includes the subject matter of any of Examples 1-9, and wherein to calculate the estimated credit loss comprises to store data indicative of the estimated credit loss resulting from the change in the selected macroeconomic variable separately from a dataset that is indicative of estimated credit losses to the multiple asset categories without the change applied to the selected macroeconomic variable.

Example 11 includes the subject matter of any of Examples 1-10, and wherein to present the estimated credit loss comprises to present estimated credit losses for each asset category for multiple changes to the selected macroeconomic variable.

Example 12 includes the subject matter of any of Examples 1-11, and wherein to present the estimated credit loss comprises to present estimated credit losses for each asset category for multiple changes to multiple macroeconomic variables.

Example 13 includes the subject matter of any of Examples 1-12, and wherein to present the estimated credit loss resulting from the change in the selected macroeconomic variable comprises to present the estimated credit loss relative to an estimated credit loss in which the selected macroeconomic variable is not changed.

Example 14 includes the subject matter of any of Examples 1-13, and wherein to present the estimated credit loss comprises to present multiple asset categories that the selected macroeconomic variable has been determined to affect, a relative magnitude of the estimated credit loss for each of the asset categories, and an aggregate impact on overall credit loss estimates across all asset categories in a portfolio.

Example 15 includes the subject matter of any of Examples 1-14, and wherein to present the estimated credit loss comprises to present the estimated credit loss in a dendogram.

Example 16 includes the subject matter of any of Examples 1-15, and wherein the circuitry is further configured to determine whether a target number of estimated credit losses have been calculated based on changes to the selected macroeconomic variable to enable streamlined prediction of credit losses for additional changes to the selected macroeconomic variable.

Example 17 includes the subject matter of any of Examples 1-16, and wherein the circuitry is further configured to perform, in response to a determination that the target number of estimated credit losses have been calculated, streamlined prediction of credit losses for at least one additional change to the selected macroeconomic variable.

Example 18 includes the subject matter of any of Examples 1-17, and wherein the circuitry is further configured to perform streamlined prediction of a credit loss by interpolating between previously calculated estimated credit losses.

Example 19 includes the subject matter of any of Examples 1-18, and wherein the circuitry is further configured to perform streamlined prediction of a credit loss with a machine learning model that has been trained on previously calculated estimated credit losses for multiple changes to the selected macroeconomic variable.

Example 20 includes the subject matter of any of Examples 1-19, and wherein the circuitry is further configured to obtain data indicative of changes to be applied to multiple selected macroeconomic variables of the set of macroeconomic variables; calculate an estimated credit loss resulting from the changes to the multiple selected macroeconomic variables; and present, in the user interface, the estimated credit loss resulting from the changes to the multiple selected macroeconomic variables.

Example 21 includes a method comprising determining, by a compute device, for each asset category in a set of multiple asset categories, a set of macroeconomic variables that affect a credit loss for the corresponding asset category; obtaining, by the compute device, data indicative of a change to be applied to a selected macroeconomic variable of the set of macroeconomic variables; calculating, by the compute device and for each asset category determined to be affected by the selected macroeconomic variable, an estimated credit loss resulting from the change in the selected macroeconomic variable while excluding from the calculation one or more asset categories from the set of multiple asset categories that have been determined to not be affected by the selected macroeconomic variable; and presenting, by the compute device and in a user interface, the estimated credit loss.

Example 22 includes the subject matter of Example 21, and wherein determining a set of macroeconomic variables that affect a credit loss for the corresponding asset category comprises performing an analysis of historical effects of each of multiple macroeconomic variables on the corresponding asset category to identify a subset of the macroeconomic variables that affect a credit loss for the corresponding asset category.

Example 23 includes the subject matter of any of Examples 21 and 22, and wherein determining the set of macroeconomic variables comprises performing an analysis of historical effects of each macroeconomic variable over multiple quarters.

Example 24 includes the subject matter of any of Examples 21-23, and wherein determining the set of macroeconomic variables comprises performing a regression analysis.

Example 25 includes the subject matter of any of Examples 21-24, and wherein determining a set of macroeconomic variables that affect a credit loss for the corresponding asset category comprises identifying one or more macroeconomic variables from the set having at least a predefined threshold effect on the credit loss for the corresponding asset category.

Example 26 includes the subject matter of any of Examples 21-25, and wherein determining for each asset category in a set of multiple asset categories, a set of macroeconomic variables that affect a credit loss for the corresponding asset category comprises producing a matrix structure indicative of macroeconomic variables that affect each asset category.

Example 27 includes the subject matter of any of Examples 21-26, and wherein obtaining data indicative of a change to be applied to a selected macroeconomic variable comprises obtaining a user-defined increase or decrease of the selected macroeconomic variable.

Example 28 includes the subject matter of any of Examples 21-27, and wherein obtaining data indicative of a change to be applied to a selected macroeconomic variable comprises predicting a change to the selected macroeconomic variable based on a historical analysis of changes to the selected macroeconomic variable over time.

Example 29 includes the subject matter of any of Examples 21-28, and wherein predicting the change to the selected macroeconomic variable comprises predicting the change with a machine learning model that has been trained to predict changes to macroeconomic variables based on historical economic data.

Example 30 includes the subject matter of any of Examples 21-29, and wherein calculating the estimated credit loss comprises storing data indicative of the estimated credit loss resulting from the change in the selected macroeconomic variable separately from a dataset that is indicative of estimated credit losses to the multiple asset categories without the change applied to the selected macroeconomic variable.

Example 31 includes the subject matter of any of Examples 21-30, and wherein presenting the estimated credit loss comprises presenting estimated credit losses for each asset category for multiple changes to the selected macroeconomic variable.

Example 32 includes the subject matter of any of Examples 21-31, and wherein presenting the estimated credit loss comprises presenting estimated credit losses for each asset category for multiple changes to multiple macroeconomic variables.

Example 33 includes the subject matter of any of Examples 21-32, and wherein presenting the estimated credit loss resulting from the change in the selected macroeconomic variable comprises presenting the estimated credit loss relative to an estimated credit loss in which the selected macroeconomic variable is not changed.

Example 34 includes the subject matter of any of Examples 21-33, and wherein presenting the estimated credit loss comprises presenting multiple asset categories that the selected macroeconomic variable has been determined to affect, a relative magnitude of the estimated credit loss for each of the asset categories, and an aggregate impact on overall credit loss estimates across all asset categories in a portfolio.

Example 35 includes the subject matter of any of Examples 21-34, and wherein presenting the estimated credit loss comprises presenting the estimated credit loss in a dendogram.

Example 36 includes the subject matter of any of Examples 21-35, and further including determining, by the compute device, whether a target number of estimated credit losses have been calculated based on changes to the selected macroeconomic variable to enable streamlined prediction of credit losses for additional changes to the selected macroeconomic variable.

Example 37 includes the subject matter of any of Examples 21-36, and further including performing, by the compute device and in response to a determination that the target number of estimated credit losses have been calculated, streamlined prediction of credit losses for at least one additional change to the selected macroeconomic variable.

Example 38 includes the subject matter of any of Examples 21-37, and further including performing, by the compute device, streamlined prediction of a credit loss by interpolating between previously calculated estimated credit losses.

Example 39 includes the subject matter of any of Examples 21-38, and further including performing, by the compute device, streamlined prediction of a credit loss with a machine learning model that has been trained on previously calculated estimated credit losses for multiple changes to the selected macroeconomic variable.

Example 40 includes the subject matter of any of Examples 21-39, and further including obtaining, by the compute device, data indicative of changes to be applied to multiple selected macroeconomic variables of the set of macroeconomic variables; calculating, by the compute device, an estimated credit loss resulting from the changes to the multiple selected macroeconomic variables; and presenting, by the compute device and in the user interface, the estimated credit loss resulting from the changes to the multiple selected macroeconomic variables.

Example 41 includes one or more machine-readable storage media comprising a plurality of instructions stored thereon that, in response to being executed, cause a compute device to determine for each asset category in a set of multiple asset categories, a set of macroeconomic variables that affect a credit loss for the corresponding asset category; obtain data indicative of a change to be applied to a selected macroeconomic variable of the set of macroeconomic variables; calculate, for each asset category determined to be affected by the selected macroeconomic variable, an estimated credit loss resulting from the change in the selected macroeconomic variable while excluding from the calculation one or more asset categories from the set of multiple asset categories that have been determined to not be affected by the selected macroeconomic variable; and present, in a user interface, the estimated credit loss.

Example 42 includes the subject matter of Example 41, and wherein to determine a set of macroeconomic variables that affect a credit loss for the corresponding asset category comprises to perform an analysis of historical effects of each of multiple macroeconomic variables on the corresponding asset category to identify a subset of the macroeconomic variables that affect a credit loss for the corresponding asset category.

Example 43 includes the subject matter of any of Examples 41 and 42, and wherein to determine the set of macroeconomic variables comprises to perform an analysis of historical effects of each macroeconomic variable over multiple quarters.

Example 44 includes the subject matter of any of Examples 41-43, and wherein to determine the set of macroeconomic variables comprises to perform a regression analysis.

Example 45 includes the subject matter of any of Examples 41-44, and wherein to determine a set of macroeconomic variables that affect a credit loss for the corresponding asset category comprises to identify one or more macroeconomic variables from the set having at least a predefined threshold effect on the credit loss for the corresponding asset category.

Example 46 includes the subject matter of any of Examples 41-45, and wherein to determine for each asset category in a set of multiple asset categories, a set of macroeconomic variables that affect a credit loss for the corresponding asset category comprises to produce a matrix structure indicative of macroeconomic variables that affect each asset category.

Example 47 includes the subject matter of any of Examples 41-46, and wherein to obtain data indicative of a change to be applied to a selected macroeconomic variable comprises to obtain a user-defined increase or decrease of the selected macroeconomic variable.

Example 48 includes the subject matter of any of Examples 41-47, and wherein to obtain data indicative of a change to be applied to a selected macroeconomic variable comprises to predict a change to the selected macroeconomic variable based on a historical analysis of changes to the selected macroeconomic variable over time.

Example 49 includes the subject matter of any of Examples 41-48, and wherein to predict the change to the selected macroeconomic variable comprises to predict the change with a machine learning model that has been trained to predict changes to macroeconomic variables based on historical economic data.

Example 50 includes the subject matter of any of Examples 41-49, and wherein to calculate the estimated credit loss comprises to store data indicative of the estimated credit loss resulting from the change in the selected macroeconomic variable separately from a dataset that is indicative of estimated credit losses to the multiple asset categories without the change applied to the selected macroeconomic variable.

Example 51 includes the subject matter of any of Examples 41-50, and wherein to present the estimated credit loss comprises to present estimated credit losses for each asset category for multiple changes to the selected macroeconomic variable.

Example 52 includes the subject matter of any of Examples 41-51, and wherein to present the estimated credit loss comprises to present estimated credit losses for each asset category for multiple changes to multiple macroeconomic variables.

Example 53 includes the subject matter of any of Examples 41-52, and wherein to present the estimated credit loss resulting from the change in the selected macroeconomic variable comprises to present the estimated credit loss relative to an estimated credit loss in which the selected macroeconomic variable is not changed.

Example 54 includes the subject matter of any of Examples 41-53, and wherein to present the estimated credit loss comprises to present multiple asset categories that the selected macroeconomic variable has been determined to affect, a relative magnitude of the estimated credit loss for each of the asset categories, and an aggregate impact on overall credit loss estimates across all asset categories in a portfolio.

Example 55 includes the subject matter of any of Examples 41-54, and wherein to present the estimated credit loss comprises to present the estimated credit loss in a dendogram.

Example 56 includes the subject matter of any of Examples 41-55, and wherein the instructions further cause the compute device to determine whether a target number of estimated credit losses have been calculated based on changes to the selected macroeconomic variable to enable streamlined prediction of credit losses for additional changes to the selected macroeconomic variable.

Example 57 includes the subject matter of any of Examples 41-56, and wherein the instructions further cause the compute device to perform, in response to a determination that the target number of estimated credit losses have been calculated, streamlined prediction of credit losses for at least one additional change to the selected macroeconomic variable.

Example 58 includes the subject matter of any of Examples 41-57, and wherein the instructions further cause the compute device to perform streamlined prediction of a credit loss by interpolating between previously calculated estimated credit losses.

Example 59 includes the subject matter of any of Examples 41-58, and wherein the instructions further cause the compute device to perform streamlined prediction of a credit loss with a machine learning model that has been trained on previously calculated estimated credit losses for multiple changes to the selected macroeconomic variable.

Example 60 includes the subject matter of any of Examples 41-59, and wherein the instructions further cause the compute device to obtain data indicative of changes to be applied to multiple selected macroeconomic variables of the set of macroeconomic variables; calculate an estimated credit loss resulting from the changes to the multiple selected macroeconomic variables; and present, in the user interface, the estimated credit loss resulting from the changes to the multiple selected macroeconomic variables.

1. A compute device comprising:
circuitry configured to:
determine for each asset category in a set of multiple asset categories, a set of macroeconomic variables that affect a credit loss for the corresponding asset category;
obtain data indicative of a change to be applied to a selected macroeconomic variable of the set of macroeconomic variables;
calculate, for each asset category determined to be affected by the selected macroeconomic variable, an estimated credit loss resulting from the change in the selected macroeconomic variable while excluding from the calculation one or more asset categories from the set of multiple asset categories that have been determined to not be affected by the selected macroeconomic variable; and
present, in a user interface, the estimated credit loss.

2. The compute device of claim 1, wherein to determine a set of macroeconomic variables that affect a credit loss for the corresponding asset category comprises to perform an analysis of historical effects of each of multiple macroeconomic variables on the corresponding asset category to identify a subset of the macroeconomic variables that affect a credit loss for the corresponding asset category.

3. The compute device of claim 2, wherein to determine the set of macroeconomic variables comprises to perform an analysis of historical effects of each macroeconomic variable over multiple quarters.

4. The compute device of claim 2, wherein to determine the set of macroeconomic variables comprises to perform a regression analysis.

5. The compute device of claim 1, wherein to determine a set of macroeconomic variables that affect a credit loss for the corresponding asset category comprises to identify one or more macroeconomic variables from the set having at least a predefined threshold effect on the credit loss for the corresponding asset category.

6. The compute device of claim 1, wherein to determine for each asset category in a set of multiple asset categories, a set of macroeconomic variables that affect a credit loss for the corresponding asset category comprises to produce a matrix structure indicative of macroeconomic variables that affect each asset category.

7. The compute device of claim 1, wherein to obtain data indicative of a change to be applied to a selected macroeconomic variable comprises to obtain a user-defined increase or decrease of the selected macroeconomic variable.

8. The compute device of claim 1, wherein to obtain data indicative of a change to be applied to a selected macroeconomic variable comprises to predict a change to the selected macroeconomic variable based on a historical analysis of changes to the selected macroeconomic variable over time.

9. The compute device of claim 8, wherein to predict the change to the selected macroeconomic variable comprises to predict the change with a machine learning model that has been trained to predict changes to macroeconomic variables based on historical economic data.

10. The compute device of claim 1, wherein to calculate the estimated credit loss comprises to store data indicative of the estimated credit loss resulting from the change in the selected macroeconomic variable separately from a dataset that is indicative of estimated credit losses to the multiple asset categories without the change applied to the selected macroeconomic variable.

11. The compute device of claim 1, wherein to present the estimated credit loss comprises to present estimated credit losses for each asset category for multiple changes to the selected macroeconomic variable.

12. The compute device of claim 1, wherein to present the estimated credit loss comprises to present estimated credit losses for each asset category for multiple changes to multiple macroeconomic variables.

13. The compute device of claim 1, wherein to present the estimated credit loss resulting from the change in the selected macroeconomic variable comprises to present the estimated credit loss relative to an estimated credit loss in which the selected macroeconomic variable is not changed.

14. The compute device of claim 1, wherein to present the estimated credit loss comprises to present multiple asset categories that the selected macroeconomic variable has been determined to affect, a relative magnitude of the estimated credit loss for each of the asset categories, and an aggregate impact on overall credit loss estimates across all asset categories in a portfolio.

15. The compute device of claim 1, wherein to present the estimated credit loss comprises to present the estimated credit loss in a dendogram.

16. The compute device of claim 1, wherein the circuitry is further configured to determine whether a target number of estimated credit losses have been calculated based on changes to the selected macroeconomic variable to enable streamlined prediction of credit losses for additional changes to the selected macroeconomic variable.

17. The compute device of claim 16, wherein the circuitry is further configured to perform, in response to a determination that the target number of estimated credit losses have been calculated, streamlined prediction of credit losses for at least one additional change to the selected macroeconomic variable.

18. The compute device of claim 1, wherein the circuitry is further configured to perform streamlined prediction of a credit loss by interpolating between previously calculated estimated credit losses.

19. A method comprising:
determining, by a compute device, for each asset category in a set of multiple asset categories, a set of macroeconomic variables that affect a credit loss for the corresponding asset category;
obtaining, by the compute device, data indicative of a change to be applied to a selected macroeconomic variable of the set of macroeconomic variables;
calculating, by the compute device and for each asset category determined to be affected by the selected macroeconomic variable, an estimated credit loss resulting from the change in the selected macroeconomic variable while excluding from the calculation one or more asset categories from the set of multiple asset categories that have been determined to not be affected by the selected macroeconomic variable; and
presenting, by the compute device and in a user interface, the estimated credit loss.

20. One or more machine-readable storage media comprising a plurality of instructions stored thereon that, in response to being executed, cause a compute device to:
determine for each asset category in a set of multiple asset categories, a set of macroeconomic variables that affect a credit loss for the corresponding asset category;
obtain data indicative of a change to be applied to a selected macroeconomic variable of the set of macroeconomic variables;
calculate, for each asset category determined to be affected by the selected macroeconomic variable, an estimated credit loss resulting from the change in the selected macroeconomic variable while excluding from the calculation one or more asset categories from the set of multiple asset categories that have been determined to not be affected by the selected macroeconomic variable; and
present, in a user interface, the estimated credit loss.
